(19) United States
(12) Patent Application Publication
(10) Pub. No.: US 2026/0340589 A1
(43) Pub. Date: Oct. 29, 2026

(54) Method for Establishing a Score of a Match on a Social Network

(71) Applicant: Yopaat B.V., Amsterdam (NL)

(72) Inventor: Huseyin Ozel, Amsterdam (NL)

(73) Assignee: Yopaat B.V., Amsterdam (NL)

(21) Appl. No.: 19/123,185

(22) PCT Filed: Oct. 24, 2022
(86) PCT No.: PCT/EP2022/079658

§ 371 Date: Apr. 22, 2025

(51) Int. Cl. G06Q 10/1053; G06Q 10/40

(52) U.S. Cl. CPC G06Q 10/1053; G06Q 10/40

(57) ABSTRACT

A computer implemented method for establishing a score of a match on a social network, comprises the steps of receiving a vacancy and at least one candidate's data comprising numerical values reflecting a skill, storing the candidate's data on a database, searching on the stored candidate's data one or more matching set of values, and computing a score of each candidate's set of data in order to compare with other candidates' data.

### OBJECT OF THE INVENTION

The present invention relates to a computer implemented method for establishing a score of a match on a social network, and in particular to a method involving receiving a vacancy and at least one candidate's data comprising numerical values reflecting a skill, storing the data on a database, searching on the stored candidate's data one or more matching set of values, and computing a score of each candidate's set of data in order to compare with other candidates' data.

### BACKGROUND OF THE INVENTION

The existing ways of using resumes and job descriptions by relying on text-based listings of work history, qualifications, skills, and responsibilities have many flaws. Both candidates and recruiters often rely on simple text keyword searches on job-boards to find matching individuals or jobs, since it is virtually impossible to fully read each résumé or job description and filter through them manually.

Simple text keyword searching is an ineffective way of identifying potential matches. Given that each resume and job description is actually in a different format and each one lists skills in different granulation, it becomes extremely difficult to effectively filter résumés and job descriptions and find reliable matches in a search.

Further, while assessing wrong candidates and wrong jobs are costly and time-consuming for individuals and businesses, actually ending up hiring the wrong individual for the wrong vacancy is even more costly as it causes lowered productivity, and wasted funds, resources, and opportunities for individuals and businesses. Although educational degrees, certifications, work history, and references are still considered important, the main consideration in terms of fit-for-job is around the skill-set of a professional in today's employment market. This is increasingly the case as the industries become further specialized and very specific job definitions emerge. However, the existing methods of job search and candidate search lag behind all these developments and fall short of the needs in the market.

Text-based résumés and job descriptions in varying formats fall short for providing an accurate snapshot view into a resume or a vacancy and also fall short for providing a deeper view in a granular, structured fashion. Even with certain existing efforts for establishing standardized formats for resumes and job descriptions, the problem around quickly providing a snapshot brief and a detailed insight is not solved as text-based documents are hard to grasp while a precise mapping for industry fields and skills is not utilized.

### DESCRIPTION OF THE INVENTION

The present invention proposes a solution for the previous art problems by providing a method for establishing a score of a match on a social network, a computer program product, a computer-readable storage medium, and a computer system as described below.

In a first inventive aspect, the invention provides a method for establishing a score of a match on a social network, the method comprising, by a computer system, the steps of:
receiving a set of data of a vacancy, the set of data of the vacancy comprising a set of vacancy skills, wherein the set of vacancy skills comprise logical conditions and numerical values,
receiving at least a set of data of at least a candidate, each set of data of a candidate comprising a set of candidate skills, wherein the set of candidate skills comprise education skills' values, certification skills' values and skill-set skills' values,
storing the set of vacancy data on a database of the computer system,
storing each set of candidate data on the database of the computer system,
searching on the database of the computer system a set of candidate skills matching the set of vacancy skills;
when the set of vacancy skills matches with at least a set of candidate skills, the method further comprises, for each matching set of candidate skills:
computing a score for the set of candidate skills,
assigning the score to the set of candidate data;
wherein the score is computed according to a weighted sum of the values of the candidate skills.

Throughout the present description, match should be understood as the situation in which a candidate data partially or fully fulfils the conditions set forth by the vacancy data; preferably, candidate and vacancy correspond to a physical person in search for a job, and a job position offered by an employer, respectively, wherein the candidate and the employer are linked through a social network.

The set of data of a vacancy or a candidate, or set of vacancy or candidate data, comprises an identification of the employer company or the candidate, and an array of values or conditions, each of them corresponding to a specific skill, where the array of values is designated set of vacancy or candidate skills. Preferably, the skills of the candidate are represented as a set of numerical values, such as integers within a range of 1 to 10, as a percentage, or as a binary number, and the skills prerequisites of the vacancy for a candidate are expressed as conditions, such as a candidate's skill value to be greater than or equal to a number. It should also be understood that the skill value is related to the level of expertise of a candidate and/or the years of experience of that candidate applying the skill.

It should be understood that for each vacancy, there may be one or more candidates, wherein a single set of data corresponds to each candidate. Each candidate is associated to a record or tuple, and each skill is associated to an attribute, or column, of the computer system database; also, the vacancy is associated with a reference record, which is used for finding a matching candidate. The computer system searches the database for a set of skills, and all those records which values met the criteria set by the vacancy, are considered a matching set of candidate skills. Then, for the matching sets of candidate skills, a score is computed, and assigned to the candidate record. Preferably, the matching sets of candidates are displayed in order according to this score.

Examples of skills are the level of proficiency in a language, and the years of experience in a certain professional field; in this respect, each skill is represented by a value, such as for example a percentage related to the proficiency in a language, or a binary value for showing whether the candidate has a driving licence or not. The skills are preferably divided into three categories: education skills, certification skills and skill-set skills; each of the skills may be assigned to one or more categories, according to the nature of the skill.

The score, S, is computed according to a weighted sum of n skills' values, that is, as a result of computing:

$$S = {\sum }_{1}^{n} {a}_{1} {x}_{1} + {a}_{2} {x}_{2} + … + {a}_{n} {x}_{n}$$

Where a₁, a₂ . . . , aₙ, are weights and x₁, x₂ . . . , xₙ, are the skills' values. The score, S, may be expressed as a percentage, as an integer or as a decimal. In a preferred embodiment, the weights are dependent on how important a skill is in the vacancy requirements, and preferably they are also dependent on the logical relations between skills. Some skills are deemed to be more important when they are grouped together, and therefore having a higher weight.

Further, the specialization of a candidate also influences the weight distribution, and therefore, in a preferred embodiment, the weight to a skill under that specialization is assigned according to the importance of the specialization, or in other words, weights for skills under important specializations are higher.

In a particular embodiment, the score of the set of candidate skills is computed according to a weighted sum of education skills' scores, certification skills' scores and skill-set skills' scores by adding the results of multiplying an education skills' score by an education skills' coefficient, a certification skills' score by a certification skills' coefficient, and a skill-set skills' score by a skill-set skills' coefficient; and wherein the education skills' scores, the certification skills' scores and the skill-set skills' scores are computed as a weighted sum of the education skills' values, the certification skills' values and the skill-set skills' values, respectively.

According to this particular embodiment, the score is computed as a weighted sum of the partial scores of the education skills' values, the certification skills' values and the skill-set skills' values, as follows:

S=b₁s₁+b₂s₂+b₃s₃

Wherein s₁, s₂ and s₃ are the scores of the education skills' values, the certification skills' values and the skill-set skills' values, respectively, b₁, b₂ and b₃ are the education skills' coefficient, the certification skills' coefficient and the skill-set skills' coefficient, respectively, and s₁, s₂ and s₃ are computed as:

$${s}_{1} = {\sum }_{1}^{i} {a}_{1} {x}_{1} + {a}_{2} {x}_{2} + … + {a}_{i} {x}_{i}$$

$${s}_{2} = {\sum }_{i + 1}^{j} {a}_{i + 1} {x}_{i + 1} + {a}_{i + 2} {x}_{i + 2} + … + {a}_{j} {x}_{j}$$

$${s}_{3} = {\sum }_{j + 1}^{n} {a}_{j + 1} {x}_{j + 1} + {a}_{j + 2} {x}_{j + 2} + … + {a}_{n} {x}_{n}$$

In a particular embodiment, the education skills' coefficient is a numerical value in a given range, wherein the value of the education skills' coefficient is proportional to the amount of education skills' conditions of the set of vacancy skills. Therefore, the weight of the education skills is dependent on the amount of the required education skills.

In a particular embodiment, the certification skills' coefficient is a numerical value in a given range, wherein the value of the certification skills' coefficient is proportional to the amount of certification skills' conditions of the set of vacancy skills. Accordingly, the weight of the certification skills is dependent on the amount of the required certification skills.

In a particular embodiment, the skill-set skills' coefficient is a numerical value in a given range, wherein the value of the skill-set skills' coefficient is proportional to the amount of skill-set skills' conditions of the set of vacancy skills. Hence, the weight of the skill-set skills is dependent on the amount of the required skill-set skills.

In a particular embodiment, the education skills' score is computed by multiplying at least an education skills' value by an education skills' weight value.

In a particular embodiment, the certification skills' score is computed by multiplying at least a certification skills' value by a certification skills' weight value.

In a particular embodiment, the skill-set skills' score is computed by multiplying at least a skill-set skills' value by a skill-set skills' weight value.

Advantageously, the education skills' weight values, the certification skills' weight values and the skill-set skills' weight values may be adjusted according to the requirements of the vacancy or the employer. Also, as an advantage, the certification skills' weight values and the skill-set skills' weight values may be adjusted according to the feedback received from previous matching operations.

In a particular embodiment, a skills' value or skills' weight value is either 1 or 0. Advantageously, a skill value and/or a skill weight value can be set to a 1 or a 0 to denote the existence or absence of an ability or condition, such as the candidate having or not a specific certification.

In a second inventive aspect, the invention provides a computer program product comprising instructions which, when the program is executed by a computer system, cause the computer system to carry out the steps of the first inventive aspect.

The computer program product is designed such that it can be provided to a requester willing to implement the method for establishing a score of a match on a social network. It can be configured such that parts of the computer program product are executed on a client computer, while other parts are executed on a server computer, both computers being interconnected by means of a data network. In an embodiment, several copies of the product parts intended to be executed by client computers are operated by one or more candidates or one or more vacancy providers.

In a third inventive aspect, the invention provides a computer-readable storage medium comprising instructions which, when executed by a computer system, cause the computer system to carry out the steps of the first inventive aspect.

The computer readable-storage medium may be, in an embodiment, a FLASH memory unit, configured to be distributed. In other embodiments, the computer readable-storage medium is a hard disk unit or a solid-state disk, SSD, unit.

In a third inventive aspect, the invention provides a computer system comprising means for carrying out the steps of the method of the first inventive aspect.

It should be understood that the computer system can be a single conventional computer or a group of computers with a connection to a data communication network such as the Internet; in a preferred embodiment, the computing system is a server of a computer network which receives data from one or more client computers interconnected by means of a data network.

### DESCRIPTION OF THE DRAWINGS

The foregoing and other advantages and features will be more fully understood from the following detailed description of exemplary embodiments with reference to the accompanying drawings, which should be considered by way of illustration and not limitation, in which:

FIG. 1 This figure represents a flow diagram of a preferred embodiment of the method.

FIG. 2 This figure represents a schematic view of a preferred embodiment of the computer system.

### PREFERRED EMBODIMENT OF THE INVENTION

Throughout the present document it will be understood that various parts of one embodiment of the invention can be freely combined with parts described in other embodiments, even being said combination not explicitly described, provided there is no harm in such combination.

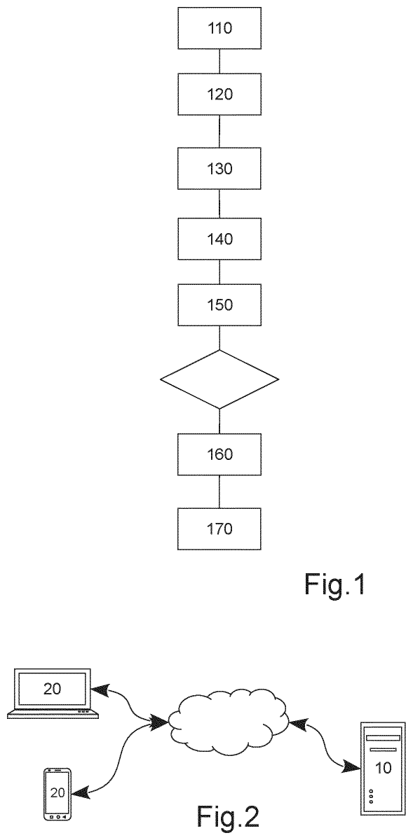

FIG. 1 shows an example of the method for establishing a score of a match on a social network. In this example, the method is intended to be executed in the computer system (10) which will be described later. The computer system (10) is in data communication with at least two user devices (20) via the Internet; for simplicity, only two user devices (20) are shown, where at least one user device (20) is operated by a candidate, and at least another user device (20) is operated by a vacancy provider, usually a human resources manager of an employer company.

According to the needs of the employer company, a set of data of a vacancy is established. In the example, the set of data of the vacancy comprises a set of vacancy skills, wherein each vacancy skill is related to a prospect employee skills and abilities, and is comprised of logical conditions or numerical values; these can include, for example, that the candidate's work experience must be higher than five years, or that the proficiency level in English must be of at least 75% in a pre-established language proficiency scale. The skills are divided into three categories: education skills, certification skills and skill-set skills.

Separately, a candidate prepares a set of candidate data, comprising a set of candidate skills, wherein the candidate skills comprise education skills' values, certification skills' values and skill-set skills' values. These values can be, depending on the particular skill, an integer value, a percentage, or a binary number. Several candidates would repeat this process in order to take part in the matching process.

The vacancy provider and the candidates send their respective sets of data with their user devices (20), which are subsequently received (110, 120) by the computer system (10). The computer system (10) then stores (130, 140) the vacancy and the candidates' sets of data in a database located in a not volatile storage unit of the computer system (10).

Once the computer system (10) has stored the set of vacancy skills and the plurality of sets of candidate skills, the computer system (10) searches (150) those sets of candidate skills fulfilling the conditions of the set of vacancy skills. If one or more of the sets of candidate skills matches the vacancy skills, the computer system (10) computes (160) a score, S, for each of the matching sets of candidate skills, and assigns (170) the corresponding score to the set of candidate data. In this example, the matching sets of candidate data are displayed at least on the employer company's user device (20) according to their score, in descending order.

The step of computing (160) the score S of a set of candidate skills is performed according to a weighted sum of the skills' values, according to their categories:

$${s}_{1} = {\sum }_{1}^{i} {a}_{1} {x}_{1} + {a}_{2} {x}_{2} + … + {a}_{i} {x}_{i}$$

$${s}_{2} = {\sum }_{i + 1}^{j} {a}_{i + 1} {x}_{i + 1} + {a}_{i + 2} {x}_{i + 2} + … + {a}_{j} {x}_{j}$$

$${s}_{3} = {\sum }_{j + 1}^{n} {a}_{j + 1} {x}_{j + 1} + {a}_{j + 2} {x}_{j + 2} + … + {a}_{n} {x}_{n}$$

Wherein s₁, s₂ and s₃ are the scores of the education skills' values, the certification skills' values and the skill-set skills' values, respectively, b₁, b₂ and b₃ are the education skills' coefficient, the certification skills' coefficient and the skill-set skills' coefficient, respectively. Finally, the score is obtained by multiplying an education skills' score by an education skills' coefficient, a certification skills' score by a certification skills' coefficient, and a skill-set skills' score by a skill-set skills' coefficient:

S=b₁s₁+b₂s₂+b₃s₃

With b₁, b₂ and bs are the education skills' coefficient, the certification skills' coefficient and the skill-set skills' coefficient, respectively.

FIG. 2 shows a preferred example of the computer system (10) in data communication with the user devices (20) from which the set of data of a vacancy and the sets of data of candidates is received in this example; for simplicity purposes, only two of the user devices (20) are shown. The computer system (10) is a conventional server type computer, while the user devices (20) may be personal computers, smartphones, tablets and the like from which candidates and company employees can access a web service of a social network enabling the access to a program executing the described method for establishing a score of a match.

1. A method for establishing a score of a match on a social network, the method comprising, by a computer system, the steps of:
(a) receiving a set of data of a vacancy, the set of data of the vacancy comprising a set of vacancy skills, wherein the set of vacancy skills comprise logical conditions and numerical values,
(b) receiving at least a set of data of at least a candidate, each set of data of a candidate comprising a set of candidate skills, wherein the set of candidate skills comprise education skills' values, certification skills' values and skill-set skills' values, storing the set of vacancy data on a database of the computer system, storing each set of candidate data on the database of the computer system, searching on the database of the computer system a set of candidate skills matching the set of vacancy skills;
when the set of vacancy skills matches with at least a set of candidate skills,
the method further comprises, for each matching set of candidate skills:
c) computing a score for the set of candidate skills,
d) assigning the score to the set of candidate data;
wherein the score is computed according to a weighted sum of the values of the candidate skills.

2. The method according to claim 1, wherein the score of the set of candidate skills is computed according to a weighted sum of education skills' scores, certification skills' scores and skill-set skills' scores by adding the results of multiplying an education skills' score by an education skills' coefficient, a certification skills' score by a certification skills' coefficient, and a skill-set skills' score by a skill-set skills' coefficient; and wherein the education skills' scores, the certification skills' scores and the skill-set skills' scores are computed as a weighted sum of the education skills' values, the certification skills' values and the skill-set skills' values, respectively.

3. The method according to claim 2, wherein the education skills' coefficient is a numerical value in a given range, wherein the value of the education skills' coefficient is proportional to the amount of education skills' conditions of the set of vacancy skills.

4. The method according to claim 2, wherein the certification skills' coefficient is a numerical value in a given range, wherein the value of the certification skills' coefficient is proportional to the amount of certification skills' conditions of the set of vacancy skills.

5. The method according to claim 2, wherein the skill-set skills' coefficient is a numerical value in a given range, wherein the value of the skill-set skills' coefficient is proportional to the amount of skill-set skills' conditions of the set of vacancy skills.

6. The method according to claim 2, wherein the education skills' score is computed by multiplying at least an education skills' value by an education skills' weight value.

7. The method according to claim 2, wherein the certification skills' score is computed by multiplying at least a certification skills' value by a certification skills' weight value.

8. The method according to claim 2, wherein the skill-set skills' score is computed by multiplying at least a skill-set skills' value by a skill-set skills' weight value.

9. The method according to claim 6, wherein a skills' value or skills' weight value is either 1 or 0.

10. A computer program product comprising instructions which, when the program is executed by a computer system, cause the computer system to carry out the steps of the method of claim 1.

11. A computer-readable storage medium comprising instructions which, when executed by a computer system, cause the computer system to carry out the steps of the method of claim 1.

12. A Computer system comprising means for carrying out the steps of the method of claim 1.
